(19) United States
(12) Patent Application Publication
(10) Pub. No.: US 2021/0265849 A1
(43) Pub. Date: Aug. 26, 2021

(54) USER-FRIENDLY CHARGER

(71) Applicant: GUANGDONG GOPOD GROUP CO., LTD, Shenzhen (CN)

(72) Inventor: Zhuowen LIAO, Shenzhen (CN)

(21) Appl. No.: 16/800,662

(22) Filed: Feb. 25, 2020

(51) Int. Cl. H02J 7/00; H02J 7/02

(52) U.S. Cl. CPC H02J 7/0042; H02J 7/02

(57) ABSTRACT

A user-friendly charger is provided, including an outer shell, a circuit board, an upper cover, a lower cover, a primary plug and a plurality of secondary plugs. The outer shell has an open first end and a second end opposite to the first end, and a receiving chamber is provided inside the outer shell. The circuit board is located inside the receiving chamber. The primary plug is configured to cover the first end of the outer shell; one end of the first conductive elastic sheet is in abutment against the two-phase pin, and the other end thereof is connected to the circuit board. The two-phase pin is rotatably connected to the outer plug housing of the primary plug, and the two-phase pin is configured to be accommodated into the accommodating slot and engaged with the secondary plug, thereby achieving stable and safe electrical connection.

### TECHNICAL FIELD

The present application pertains to the technical field of charger, and in particular to a user-friendly charger.

### BACKGROUND

In present society, chargers are widely used, which can provide stable and reliable DC power for electronic devices with power storage function. There are some defects in the existing charger, such as unstable connection between charging plug and circuit board, inconvenient assembly and prone to cause open-circuit or short-circuit, and the existing charger is only equipped with a single type of charging plug, which can't adapt to a variety of types of charging sockets.

### SUMMARY

In order to solve said technical problems in the prior art, the present application provides a user-friendly charger, conductive elastic sheets are used to electrically connect with the circuit board, thereby achieving higher stability and safety of the circuit, and achieving convenient assembly. And the primary plug can be plugged into a variety of types of secondary plugs, such that the charger can be adapted to a variety of types of charging sockets, which is convenient for use and improves the user experience.

A user-friendly charger is provided, including an outer shell, a circuit board, an upper cover, a lower cover, a primary plug and a plurality of secondary plugs. The outer shell has an open first end and a second end opposite to the first end, the second end is provided with a receiving port on an end face, the outer shell is provided with an opening in a side adjacent to the first end, and a receiving chamber is provided inside the outer shell. The circuit board is fixed by the upper cover and the lower cover, and is located inside the receiving chamber. A charging port is fixedly disposed at the circuit board, and the charging port is inserted into the receiving port such that outer edge of the charging port is in flush with the end face of the second end. The primary plug includes an outer plug housing, an inner plug housing, a two-phase pin, and two first conductive elastic sheets, and an outer side of the outer plug housing is provided with an accommodating slot having an open end. The primary plug is configured to cover the first end of the outer shell, and the open end of the accommodating slot matches the opening of the outer shell; the first conductive elastic sheets are sandwiched between the outer plug housing and the inner plug housing, with one end of the first conductive elastic sheet being in abutment against the two-phase pin, and the other end thereof being connected to the circuit board. And the two-phase pin is rotatably connected to the outer plug housing, and the two-phase pin is configured to be accommodated into the accommodating slot and engaged with the secondary plug, thereby achieving electrical connection.

Further, the secondary plug includes two-phase plugs, three-phase plugs, round plugs, and flat plugs.

Further, the accommodating slot is divided into a first accommodating slot and a second accommodating slot by a block therebetween, two pins of the two-phase pin are respectively placed in the first accommodating slot and the second accommodating slot on both sides of the block, the middle of an outer side of the block is provided with a third receiving slot having an open end, and the third receiving slot is parallel to the first accommodating slot and the second accommodating slot. The secondary plug includes a base, pins provided at one end of the base, second conductive elastic sheets provided inside the base, and a snap member provided at the other end of the base. The snap member includes a first hollow snap block and a second hollow snap block provided on both sides thereof to match the first accommodating slot and the second accommodating slot, respectively, and a third clamping block provided in the middle and configured to match the third receiving slot. One end of the second conductive elastic sheet is placed in the hollow snap block, and the other end is electrically connected to the pin. The electrical connection between the primary plug and the secondary plug is realized by inserting the pins of the two-phase pin into the hollow snap blocks and engaging the third clamping block into the third receiving slot.

Further, the third receiving slot is configured to have a narrow surface layer and a wide inner layer, and the third clamping block is configured to have a wide outer layer and a narrow inner layer.

Further, a stopper opening is provided transverse to the third receiving slot at the bottom of the third receiving slot, and a stopper protrusion is provided transverse to the third clamping block at the top of the third clamping block, and the stopper opening is snap-fitted with the stopper protrusion.

Further, one end of the two-phase pin is fixed by a fastening member. The fastening member includes two insulation fastening blocks provided on both sides and a connecting rod connecting the two insulation fastening blocks. The two pins of the two-phase pin are respectively inserted into the two insulation fastening blocks, and pass through and protrude from the insulation fastening block. At an end far from the open end of the accommodating slot, a retention slot is provided at the bottom of the block and the first accommodating slot and the second accommodating slot are provided with mounting openings. The two-phase pin is placed in the first accommodating slot and the second accommodating slot by inserting into the mounting openings, the connecting rod is placed in the retention slot, the fixed connection of the outer plug housing and the inner plug housing further constrains the connecting rod within the retention slot, and a portion of the two-phase pin protruding from the insulation fastening block abuts against the first conductive elastic sheet.

Further, two ends of the first conductive elastic sheet are bent, and a middle section of the first conductive elastic sheet is flat, the first conductive elastic sheet is provided with holes. The middle section is sandwiched and fixed between the outer plug housing and the inner plug housing, and one end of the first conductive elastic sheet is fixedly connected to the circuit board by screw.

Further, the other end of the first conductive elastic sheet is bent outwardly in a certain angle, the two-phase pin is rotatable about the retention slot, and the two-phase pin and the first conductive elastic sheet are always electrically connected when the two-phase pin is switched between a first position and a second position. In the first position, the two-phase pin is received in the accommodating slot, and one end of the two-phase pin abuts a bent section of the first conductive elastic sheet; and in the second position, the two-phase pin is perpendicular to the first end, and one end of the two-phase pin abuts the middle section of the first conductive elastic sheet.

Further, two latching slots flush in height is provided at a lower end of inner sidewalls of the outer shell, and both sides of the lower cover are latched into the latching slots, such that the outer shell is fixed relative to received internal structures.

Further, the first end of the outer shell is provided with clamping slots circumferentially, an inner side of the primary plug is provided with a plurality of fastening blocks circumferentially, and the primary plug is snap-fitted with the outer shell through the fastening blocks and the clamping slots.

Further, a plurality of the charging ports can be provided, correspondingly, a plurality of the receiving ports corresponding thereto are provided, and the charging ports include USB charging ports and Type-C charging ports.

The present application provides a user-friendly charger, conductive elastic sheets are used to electrically connect with the circuit board, the circuit is more stable, the safety is higher, and the assembly is convenient, and the primary plug can be inserted into various types of secondary plugs, making the charger adapted to a variety of types of charging sockets, with convenient use and good user experience.

### BRIEF DESCRIPTION OF THE DRAWINGS

In order to explain the technical solution of embodiments of the present application more clearly, the accompanying drawings used in the embodiments of the present application or in the description of the prior art will be briefly introduced below. Obviously, the accompanying drawings described below are only some embodiments of the present application. For those of ordinary skill in the art, other drawings may be obtained based on these drawings without paying creative labor.

FIG. 1 shows a structural diagram of a user-friendly charger according to an embodiment of the present application.

FIG. 2 shows a structural diagram of a user-friendly charger in another perspective according to an embodiment of the present application.

FIG. 3 shows a structural diagram of a secondary plug of a user-friendly charger according to an embodiment of the present application.

### DETAILED DESCRIPTION

In order to make the technical problems, technical solutions and beneficial effects of the present application to be more clearly understood, the present application will be further described in detail below with reference to the accompanying drawings and embodiments. It should be understood that the specific embodiments described herein are only used to explain the present application and are not intended to limit the present application.

It should be noted that when an element is referred to as being “fixed to”, “arranged at”, “disposed on” another element, it may be directly or indirectly fixed to/arranged at/disposed on the other element. When an element is referred to as being “connected to” another element, it can be directly or indirectly connected to the other element.

In addition, the terms “first” and “second” are used for descriptive purposes only and cannot be understood as indicating or implying relative importance or implicitly indicating the number of technical features indicated. Therefore, the features defined with “first” and “second” may explicitly or implicitly include one or more of the features. In the description of the present application, the meaning of “a plurality of” is two or more, unless specifically defined otherwise. The meaning of “several”, “various” or “a variety of” is one or more, unless specifically defined otherwise.

In the description of the present application, it should be understood that the terms “middle”, “length”, “width”, “thickness”, “upper”, “lower”, “front”, “rear”, “left”, “right”, “vertical”, “horizontal”, “top”, “bottom”, “inner”, “outer”, etc. indicate orientations or positional relationships based on the orientations or positional relationships shown in the drawings, only for convenience of describing the present application and simplifying the description, rather than indicating or implying that the device or element referred to must have a particular orientation, or be constructed and operated in a particular orientation, therefore they should not be construed as limiting the present application.

In the description of the present application, it should be noted that the terms “install”, “fix”, “connect”, “fit” and “match” should be understood in a general sense unless explicitly stated and limited otherwise. For example, they may be non-removable connections, removable connections, or integrated connections; they may be mechanical connections or electrical connections; they may be direct connections or indirect connections through an intermediate medium; they may be internal connections of two elements or interaction relationships between two elements. For those of ordinary skill in the art, the specific meanings of the above terms in the present application can be understood according to specific situations.

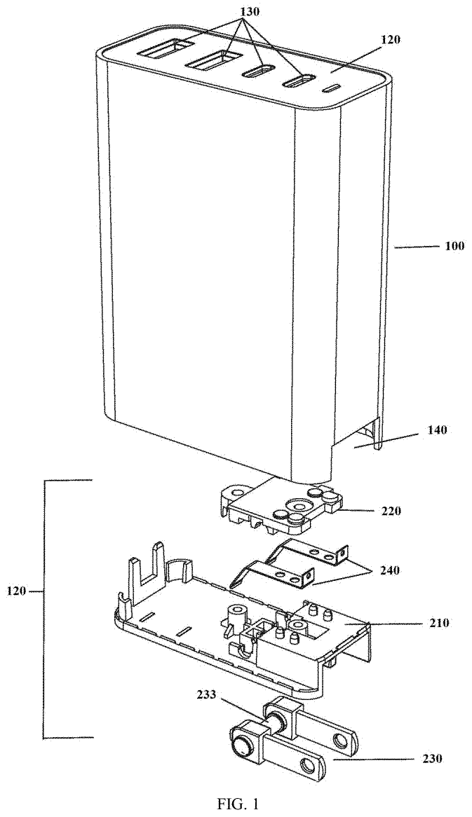

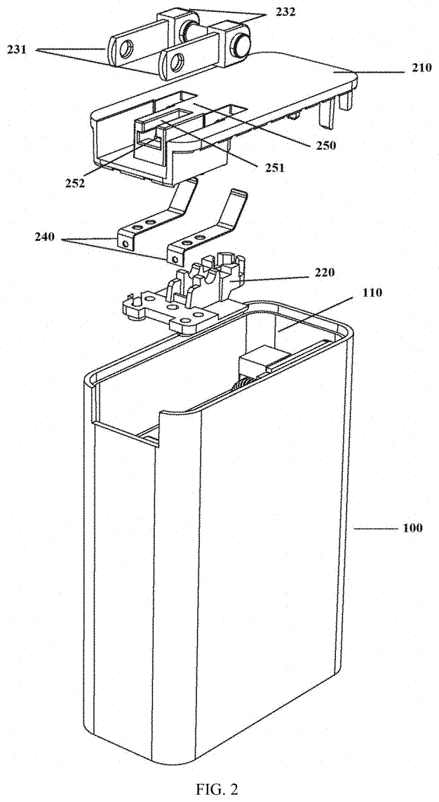

Referring to FIGS. 1-2, in the embodiments of the present application, a user-friendly charger is provided, including an outer shell 100, a circuit board, an upper cover, a lower cover, a primary plug 200 and a plurality of secondary plugs 300. The outer shell 100 has an open first end 110 and a second end 120 opposite to the first end 110, the second end 120 is provided with a receiving port 130 on an end face, the outer shell 100 is provided with an opening 140 in a side adjacent to the first end 110, and a receiving chamber is provided inside the outer shell 100. The circuit board is fixed by the upper cover and the lower cover, and is located inside the receiving chamber. A charging port is fixedly disposed at the circuit board, and the charging port is inserted into the receiving port 130 such that outer edge of the charging port is in flush with the end face of the second end 120. The primary plug 200 includes an outer plug housing 210, an inner plug housing 220, a two-phase pin 230 and two first conductive elastic sheets 240, and an outer side of the outer plug housing 210 is provided with an accommodating slot having an open end. The primary plug 200 is configured to cover the first end 110 of the outer shell 100, and the open end of the accommodating slot matches the opening 140 of the outer shell 100; the first conductive elastic sheets 240 are sandwiched between the outer plug housing 210 and the inner plug housing 220, with one end of the first conductive elastic sheet 240 being in abutment against the two-phase pin 230, and the other end thereof being connected to the circuit board. And the two-phase pin 230 is rotatably connected to the outer plug housing 210, and the two-phase pin 230 is configured to be accommodated into the accommodating slot and engaged with the secondary plug 300, thereby achieving electrical connection. One end of the first conductive elastic sheet elastically abuts against the two-phase pin of the primary plug, and the other end is electrically connected with the circuit board, thereby improving the stability and safety of the circuit, and it is easy to assemble. In addition, the primary plug can be engaged with a variety of types of secondary plugs, thereby realizing the adaptation with different types of charging sockets, making the charger convenient to use, which greatly improves the user experience.

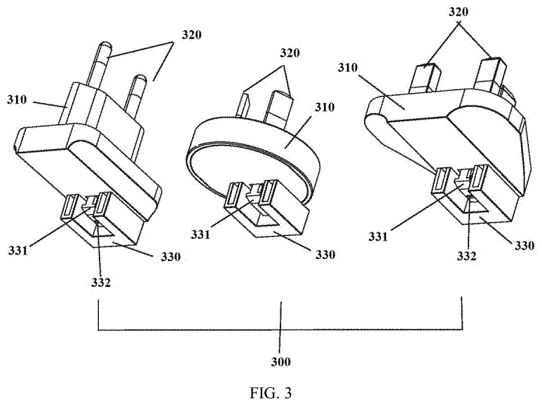

In the embodiments of the present application, the secondary plug 300 includes but is not limited to two-phase plugs, three-phase plugs, round plugs, and flat plugs. FIG. 3 shows exemplary configurations of the second plug 300.

In the embodiments of the present application, a portion of the outer side of the outer plug housing 210 above the conductive elastic sheets 240 is recessed to form the accommodating slot, and an end of the accommodating slot is open. The accommodating slot is divided into a first accommodating slot and a second accommodating slot by a block 250 therebetween. Two pins of the two-phase pin 230 are respectively placed in the first accommodating slot and the second accommodating slot on both sides of the block 250, and the middle of an outer side of the block 250 is provided with a third receiving slot 251 having an open end, and the third receiving slot 251 is parallel to the first accommodating slot and the second accommodating slot. The secondary plug 300 includes a base 310, pins 320 provided at one end of the base 310, second conductive elastic sheets provided inside the base 310, and a snap member 330 provided at the other end of the base 310. The snap member 330 includes a first hollow snap block and a second hollow snap block provided on both sides thereof to match the first accommodating slot and the second accommodating slot, respectively, and a third clamping block 331 provided in the middle and configured to match the third receiving slot 251. One end of the second conductive elastic sheet is placed in the hollow snap block, and the other end is electrically connected to the pin 320. And the electrical connection between the primary plug 200 and the secondary plug 300 is realized by inserting the pins of the two-phase pin 230 into the hollow snap blocks and engaging the third clamping block 331 into the third receiving slot 251, such a connection has high stability and takes less space.

In the embodiments of the present application, the third receiving slot 251 is configured to have a narrow surface layer and a wide inner layer, and the third clamping block 331 is configured to have a wide outer layer and a narrow inner layer. Further, a stopper opening 252 is provided transverse to the third receiving slot 251 at the bottom of the third receiving slot 251, and a stopper protrusion 332 is provided transverse to the third clamping block 331 at the top of the third clamping block 331, and the stopper opening 252 is snap-fitted with the stopper protrusion 332. This further enhances the stability of the connection of the primary plug 200 and the secondary plug 300.

In the embodiments of the present application, one end of the two-phase pin 230 is fixed by a fastening member. The fastening member includes two insulation fastening blocks 232 provided on both sides and a connecting rod 233 connecting the two insulation fastening blocks 232. The two pins 231 of the two-phase pin 230 are respectively inserted into the two insulation fastening blocks 232, and pass through and protrude from the insulation fastening block 232. At an end far from the open end of the accommodating slot, a retention slot is provided at the bottom of the block 250 and the first accommodating slot and the second accommodating slot are provided with mounting openings. The two-phase pin 230 is placed in the first accommodating slot and the second accommodating slot by inserting into the mounting openings, the connecting rod 233 is placed in the retention slot, and the fixed connection of the outer plug housing 210 and the inner plug housing 220 further constrains the connecting rod 233 within the retention slot, which is convenient for assembly. Further, a portion of the two-phase pin 230 protruding from the insulation fastening block 232 abuts against the first conductive elastic sheet 240, the two-phase pin 230 is always electrically connected with the conductive elastic sheet 240, such that the stability of connection is high.

In the embodiments of the present application, two ends of the first conductive elastic sheet 240 are bent, and a middle section of the first conductive elastic sheet 240 is flat, the first conductive elastic sheet 240 is provided with holes. The middle section is sandwiched and fixed between the outer plug housing 210 and the inner plug housing 220, and one end of the first conductive elastic sheet 240 is fixedly connected to the circuit board by screw, which further improves the stability of the inner circuit of the charger. Further, the other end of the first conductive elastic sheet 240 is bent outwardly in a certain angle, the two-phase pin 230 is rotatable about the retention slot, and the two-phase pin 230 and the first conductive elastic sheet 240 are always electrically connected when the two-phase pin 230 is switched between a first position and a second position. When in the first position, the two-phase pin 230 is received in the accommodating slot, and one end of the two-phase pin 230 abuts a bent section of the first conductive elastic sheet 240; and when in the second position, the two-phase pin 230 is perpendicular to the first end 110, and one end of the two-phase pin 230 abuts the middle section of the first conductive elastic sheet 240. High connection stability, convenient and flexible use, and space saving are thus realized.

In the embodiments of the present application, two latching slots flush in height is provided at a lower end of inner sidewalls of the outer shell 100, and both sides of the lower cover are latched into the latching slots, such that the outer shell 100 is fixed relative to received internal structures.

In the embodiments of the present application, the first end 110 of the outer shell 100 is provided with clamping slots circumferentially, an inner side of the primary plug 200 is provided with a plurality of fastening blocks circumferentially, and the primary plug 200 is snap-fitted with the outer shell 100 through the fastening blocks and the clamping slots. Such a connection is stable and convenient for assembly.

In the embodiments of the present application, a plurality of the charging ports can be provided, correspondingly, a plurality of the receiving ports 130 corresponding thereto are provided, and the charging ports include but are not limited to USB charging ports and Type-C charging ports.

The present application provides a user-friendly charger, conductive elastic sheets are used to electrically connect with the circuit board, the stability and safety of the circuit is higher, and the assembly is convenient, by inserting the primary plug into various types of secondary plugs, the charger is adapted to a variety of types of charging sockets, improving the user experience, and the connecting manner of the primary plug and the secondary plug greatly saves space.

In the case of no contradiction, the features in an embodiment or different embodiments of the present application may be combined with each other. The embodiments described above are only preferred embodiments of the present application and are not intended to limit the present application. Any modification, equivalent replacement, and improvement made within the spirit and principle of the present invention should be included in the protection scope of present invention.

What is claimed is:

1. A user-friendly charger, comprising an outer shell, a circuit board, an upper cover, a lower cover, a primary plug and a plurality of secondary plugs,
wherein
the outer shell has an open first end and a second end opposite to the first end, the second end is provided with a receiving port on an end face, the outer shell is provided with an opening in a side adjacent to the first end, and a receiving chamber is provided inside the outer shell;
the circuit board is fixed by the upper cover and the lower cover, and is located inside the receiving chamber;
a charging port is fixedly disposed at the circuit board, and the charging port is inserted into the receiving port such that outer edge of the charging port is in flush with the end face of the second end;
the primary plug comprises an outer plug housing, an inner plug housing, a two-phase pin, and two first conductive elastic sheets, and an outer side of the outer plug housing is provided with an accommodating slot having an open end;
the primary plug is configured to cover the first end of the outer shell, and the open end of the accommodating slot matches the opening of the outer shell; the first conductive elastic sheets are sandwiched between the outer plug housing and the inner plug housing, with one end of the first conductive elastic sheet being in abutment against the two-phase pin, and the other end thereof being connected to the circuit board; and
the two-phase pin is rotatably connected to the outer plug housing, and the two-phase pin is configured to be accommodated into the accommodating slot and engaged with the secondary plug, thereby achieving electrical connection.

2. The charger according to claim 1, wherein the secondary plug comprises two-phase plugs, three-phase plugs, round plugs, and flat plugs.

3. The charger according to claim 2, wherein
the accommodating slot is divided into a first accommodating slot and a second accommodating slot by a block therebetween, two pins of the two-phase pin are respectively placed in the first accommodating slot and the second accommodating slot on both sides of the block, the middle of an outer side of the block is provided with a third receiving slot having an open end, and the third receiving slot is parallel to the first accommodating slot and the second accommodating slot;
the secondary plug comprises a base, pins provided at one end of the base, second conductive elastic sheets provided inside the base, and a snap member provided at the other end of the base;
the snap member comprises a first hollow snap block and a second hollow snap block provided on both sides thereof to match the first accommodating slot and the second accommodating slot, respectively, and a third clamping block provided in the middle and configured to match the third receiving slot;
one end of the second conductive elastic sheet is placed in the hollow snap block, and the other end is electrically connected to the pin, wherein the electrical connection between the primary plug and the secondary plug is realized by inserting the pins of the two-phase pin into the hollow snap blocks and engaging the third clamping block into the third receiving slot.

4. The charger according to claim 3, wherein the third receiving slot is configured to have a narrow surface layer and a wide inner layer, and the third clamping block is configured to have a wide outer layer and a narrow inner layer.

5. The charger according to claim 4, wherein a stopper opening is provided transverse to the third receiving slot at the bottom of the third receiving slot, and a stopper protrusion is provided transverse to the third clamping block at the top of the third clamping block, and the stopper opening is snap-fitted with the stopper protrusion.

6. The charger according to claim 3, wherein one end of the two-phase pin is fixed by a fastening member, wherein
the fastening member comprises two insulation fastening blocks provided on both sides and a connecting rod connecting the two insulation fastening blocks, and the two pins of the two-phase pin are respectively inserted into the two insulation fastening blocks, and pass through and protrude from the insulation fastening block;
at an end far from the open end of the accommodating slot, a retention slot is provided at the bottom of the block and the first accommodating slot and the second accommodating slot are provided with mounting openings; and
the two-phase pin is placed in the first accommodating slot and the second accommodating slot by inserting into the mounting openings, the connecting rod is placed in the retention slot, the fixed connection of the outer plug housing and the inner plug housing further constrains the connecting rod within the retention slot, and a portion of the two-phase pin protruding from the insulation fastening block abuts against the first conductive elastic sheet.

7. The charger according to claim 5, wherein one end of the two-phase pin is fixed by a fastening member, wherein
the fastening member comprises two insulation fastening blocks provided on both sides and a connecting rod connecting the two insulation fastening blocks, and the two pins of the two-phase pin are respectively inserted into the two insulation fastening blocks, and pass through and protrude from the insulation fastening block;
at an end far from the open end of the accommodating slot, a retention slot is provided at the bottom of the block and the first accommodating slot and the second accommodating slot are provided with mounting openings; and
the two-phase pin is placed in the first accommodating slot and the second accommodating slot by inserting into the mounting openings, the connecting rod is placed in the retention slot, the fixed connection of the outer plug housing and the inner plug housing further constrains the connecting rod within the retention slot, and a portion of the two-phase pin protruding from the insulation fastening block abuts against the first conductive elastic sheet.

8. The charger according to claim 6, wherein two ends of the first conductive elastic sheet are bent, and a middle section of the first conductive elastic sheet is flat, the first conductive elastic sheet is provided with holes, wherein the middle section is sandwiched and fixed between the outer plug housing and the inner plug housing, and one end of the first conductive elastic sheet is fixedly connected to the circuit board by screw.

9. The charger according to claim 7, wherein two ends of the first conductive elastic sheet are bent, and a middle section of the first conductive elastic sheet is flat, the first conductive elastic sheet is provided with holes, wherein the middle section is sandwiched and fixed between the outer plug housing and the inner plug housing, and one end of the first conductive elastic sheet is fixedly connected to the circuit board by screw.

10. The charger according to claim 8, wherein the other end of the first conductive elastic sheet is bent outwardly in a certain angle, the two-phase pin is rotatable about the retention slot, and the two-phase pin and the first conductive elastic sheet are always electrically connected when the two-phase pin is switched between a first position and a second position, wherein
in the first position, the two-phase pin is received in the accommodating slot, and one end of the two-phase pin abuts a bent section of the first conductive elastic sheet; and
in the second position, the two-phase pin is perpendicular to the first end, and one end of the two-phase pin abuts the middle section of the first conductive elastic sheet.

11. The charger according to claim 9, wherein the other end of the first conductive elastic sheet is bent outwardly in a certain angle, the two-phase pin is rotatable about the retention slot, and the two-phase pin and the first conductive elastic sheet are always electrically connected when the two-phase pin is switched between a first position and a second position, wherein
in the first position, the two-phase pin is received in the accommodating slot, and one end of the two-phase pin abuts a bent section of the first conductive elastic sheet; and
in the second position, the two-phase pin is perpendicular to the first end, and one end of the two-phase pin abuts the middle section of the first conductive elastic sheet.

12. The charger according to claim 3, wherein two latching slots flush in height is provided at a lower end of inner sidewalls of the outer shell, and both sides of the lower cover are latched into the latching slots, such that the outer shell is fixed relative to received internal structures.

13. The charger according to claim 10, wherein two latching slots flush in height is provided at a lower end of inner sidewalls of the outer shell, and both sides of the lower cover are latched into the latching slots, such that the outer shell is fixed relative to received internal structures.

14. The charger according to claim 11, wherein two latching slots flush in height is provided at a lower end of inner sidewalls of the outer shell, and both sides of the lower cover are latched into the latching slots, such that the outer shell is fixed relative to received internal structures.

15. The charger according to claim 3, wherein the first end of the outer shell is provided with clamping slots circumferentially, an inner side of the primary plug is provided with a plurality of fastening blocks circumferentially, and the primary plug is snap-fitted with the outer shell through the fastening blocks and the clamping slots.

16. The charger according to claim 10, wherein the first end of the outer shell is provided with clamping slots circumferentially, an inner side of the primary plug is provided with a plurality of fastening blocks circumferentially, and the primary plug is snap-fitted with the outer shell through the fastening blocks and the clamping slots.

17. The charger according to claim 11, wherein the first end of the outer shell is provided with clamping slots circumferentially, an inner side of the primary plug is provided with a plurality of fastening blocks circumferentially, and the primary plug is snap-fitted with the outer shell through the fastening blocks and the clamping slots.

18. The charger according to claim 3, wherein a plurality of the charging ports can be provided, correspondingly, a plurality of the receiving ports corresponding thereto are provided, and the charging ports comprise USB charging ports and Type-C charging ports.

19. The charger according to claim 10, wherein a plurality of the charging ports can be provided, correspondingly, a plurality of the receiving ports corresponding thereto are provided, and the charging ports comprise USB charging ports and Type-C charging ports.

20. The charger according to claim 11, wherein a plurality of the charging ports can be provided, correspondingly, a plurality of the receiving ports corresponding thereto are provided, and the charging ports comprise USB charging ports and Type-C charging ports.
